(19) United States
(12) Patent Application Publication
(10) Pub. No.: US 2015/0349412 A1
(43) Pub. Date: Dec. 3, 2015

(54) PATCH ARRAY ANTENNA AND APPARATUS FOR TRANSMITTING AND RECEIVING RADAR SIGNAL INCLUDING THE SAME

(71) Applicant: HYUNDAI MOBIS CO., LTD., Seoul (KR)

(72) Inventors: Sung Joo KIM, Yongin (KR); Sang Ho NAM, Yongin (KR)

(21) Appl. No.: 14/321,694

(22) Filed: Jul. 1, 2014

(30) Foreign Application Priority Data
May 30, 2014 (KR) 10-2014-0065602

(51) Int. Cl. H01Q 1/32; G01S 13/02; G01S 13/93; H01Q 9/04; H01Q 21/00

(52) U.S. Cl. CPC H01Q 1/3233; H01Q 9/045; H01Q 21/0006; G01S 13/931; G01S 13/02; G01S 2013/0254

(57) ABSTRACT

The present invention suggest a patch array antenna which secures a side lobe level by changing a width of a feeder without changing a radiator and a radar signal transmitting and receiving apparatus including the same. The present invention provides a patch array antenna, including: a first unit element which includes a first patch which creates a predetermined radiation pattern and first feeders which are formed at both sides of the first patch and have the same width; and a second unit element is adjacent to the first unit element and includes a second patch which creates a radiation pattern and second feeders which are formed at both sides of the second patch and have the same width in which the width of the second feeders is different from the width of the first feeders.

### CROSS-REFERENCE TO RELATED APPLICATIONS

This application claims priority to and the benefit of Korean Patent Application No. 10-2014-0065602 filed in the Korean Intellectual Property Office on May 30, 2014, the entire contents of which are incorporated herein by reference.

### TECHNICAL FIELD

The present invention relates to a patch array antenna and an apparatus for transmitting and receiving a radar signal including the same and more particularly, to a patch array antenna which is available in a millimeter frequency band and an apparatus for transmitting and receiving a radar signal including the same.

### BACKGROUND ART

Recently, a study on a detecting system which detects surroundings of a vehicle for the purpose of safety and convenience of a driver has gained ground. A vehicle detecting system is used for various purposes, for example, to detect objects around the vehicle to prevent collision with an object which is not recognized by a driver and detect an empty space to perform an automatic parking function, and provides the most essential data for automatic vehicle control.

Recently, a detection technique using a radar having an excellent detection performance as compared with a detecting sensor such as an infrared sensor or an ultrasonic sensor attracts attention and a radar is used for many vehicles for more precise detection.

A radar radiates a beam and detects the surrounding area using a reflected signal and scans the surrounding area at a minute angle so as to precisely detect the neighboring object. To this end, the radar includes an array antenna.

However, a radiation pattern of the array antenna is determined by a radiant quantity of each unit element and has a Fourier transform relationship with the radiant quantity. Therefore, in order to secure a side lobe level of a given radiation pattern, each unit element needs to adjust a radiant quantity of the unit element suitable for the side lobe level. When the radiant quantity of unit elements of the array antenna are the same, the side lobe level is approximately −13.2 dB in theory. However, generally, the radar requires a side lobe level which is lower than −13.2 dB in order to transmit a small side lobe signal, so that the radiant quantity of the unit elements need to be adjusted.

German Unexamined Patent Application Publication No. 102010051094 suggests an antenna having directivity. However, in this publication, a travelling wave series fed array antenna in which an end terminal is grounded with a resistor so that a reflective wave is not generated is suggested. Therefore, a via for a resistor or ground needs to be implemented on a PCB. However, it is not easy to implement a resistor at a high millimeter frequency band of the vehicle radar and material cost is disadvantageously increased even when the resistor is implemented. When a via for ground is configured, the via is sensitive to a process error so that a high precision process is required.

### SUMMARY OF THE INVENTION

The present invention has been made in an effort to provide a patch array antenna which modifies a width of a feeder to secure a side lobe level without changing a radiator and an apparatus for transmitting and receiving a radar signal including the same.

However, an object of the present invention is not limited to the above description and other objects which have not been mentioned above will be apparent to those skilled in the art from reading the following description.

An exemplary embodiment of the present invention provides a patch array antenna, including: a first unit element which includes a first patch which creates a predetermined radiation pattern and first feeders which are formed at both sides of the first patch and have the same width; and a second unit element which is adjacent to the first unit element and includes a second patch which creates the radiation pattern and second feeders which are formed at both sides of the second patch and have the same width wherein the width of the second feeders is different from the width of the first feeders. As an example to be carried out, the first feeders have a larger width than the second feeders.

In the first unit element, a width of the first feeder may be adjusted in accordance with a radiant quantity related with the radiation pattern. The width of the first feeder may be adjusted so as to be inversely proportionate to the radiant quantity. As an example to be carried out, as the width of the first feeder is decreased, the radiant quantity is increased but as the width of the first feeder is increased, the radiant quantity is relatively reduced.

The patch array antenna may further include a third unit element which is adjacent to the second unit element and includes a third patch which creates a radiation pattern and third feeders which are formed at both sides of the third patch and have the same width; the first feeders of the first unit element, the second feeders of the second unit element, and the third feeders of the third unit element have different widths from each other and the widths of the feeders are adjusted in accordance with the radiant quantity of individual unit elements in order to secure a side lobe level of the array antenna. As an example to be carried out, the first feeders of the first unit element which is disposed at one side have the largest width, the third feeders of the third unit element which is disposed at the other side have the smallest width, and the second feeders of the second unit element which is disposed in the middle of the first unit element and the third unit element may have a width which is smaller than that of the first feeders and larger than that of the third feeders.

The patch array antenna may further include a fourth unit element which is adjacent to the second unit element and includes a fourth patch which creates a radiation pattern and fourth feeders which are formed at both sides of the fourth patch and have the same width; and a fifth unit element which is adjacent to the fourth unit element and includes a fifth patch which creates a radiation pattern and fifth feeders which are formed at both sides of the fifth patch and have the same width.

A width of each feeder may be adjusted in accordance with a radiant quantity of each unit element. As an example to be carried out, the fourth feeders have the same width as the second feeders and the fifth feeders have the same width as the first feeders.

The first unit element and the second unit element may be formed on a dielectric substrate.

The first unit element and the second element may be formed on the dielectric substrate as a Teflon type or a printed circuit board (PCB) type on which a ground plane is formed.

The patch array antenna may include a predetermined number of patches including the first patch and the second patch, and among the predetermined number of patches, at least one patch which is disposed at an end terminal may have an open side. At least one patch which is disposed at an end terminal may not have one feeder which is not connected to a feeder of the other patch between two feeders disposed at both sides of the patch. As an example to be carried out, an end terminal which is opposite to the feeder of the array antenna may be disposed so as not to include a feeder at the end terminal and to be open.

The first patch and the second patch may be formed to have the same shape as any one of a polygon and a polygon in which opposite corners are chamfered. The first feeders and the second feeders may have the same length based on a guided wavelength.

The patch array antenna may be implemented by a microstrip antenna having a series fed structure.

Another exemplary embodiment of the present invention provides a radar signal transmitting and receiving apparatus including: a radar signal generating unit which generates a radar signal; and a patch array antenna including a first unit element which outputs the radar signal to the outside and receives the radar signal which returns by being reflected and includes a first patch which creates a predetermined radiation pattern and first feeders which are formed at both sides of the first patch and have the same width; and a second unit element which is adjacent to the first unit element and includes a second patch which creates the radiation pattern and second feeders which are formed at both sides of the second patch and have the same width wherein the width of the second feeders is different from the width of the first feeders.

The radar signal transmitting and receiving apparatus may be mounted in a vehicle.

The patch array antenna may output the radar signal as a polarized wave signal having a predetermined angle. The patch array antenna may output the radar signal as a 45 degree polarized wave signal.

According to the present invention, a width of a feeder is changed without changing a radiator in a patch array antenna to secure a side lobe level so that the following effects may be achieved.

First, the side lobe level is secured by adjusting only the width of the feeder without changing the radiator so that the side lobe level is easily adjusted to improve a radiation performance of the antenna.

Second, when the radiator is changed in order to adjust the side lobe level, the feeder needs to be designed and finely adjusted for every radiator but the side lobe level is secured by adjusting only the width of the feeder so that convenience of design is increased.

Third, a via for a resistor or a ground at the end terminal of the antenna is omitted so that an etching process is simplified.

Fourth, the resistor at the end terminal of the antenna is omitted so that the number of components is reduced.

Fifth, the resistor and the via at the end terminal of the antenna are omitted so that production cost is reduced.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a conceptual diagram of a vehicle in which a radar according to an exemplary embodiment of the present invention is mounted.

FIG. 2 is a diagram of a first exemplary embodiment of an antenna and an RF module which configure a millimeter wave radar for a vehicle.

FIG. 3 is a diagram of a second exemplary embodiment of an antenna and an RF module which configure a millimeter wave radar for a vehicle.

FIG. 4 is a conceptual diagram of a first exemplary embodiment of an antenna according to an exemplary embodiment of the present invention.

FIG. 5 is an enlarged view enlarging a first unit element and a second unit element which is adjacent to the first unit element in the antenna of FIG. 4.

FIG. 6 is a perspective view of an antenna according to an exemplary embodiment of the present invention.

FIG. 7 is a side view of an antenna according to an exemplary embodiment of the present invention.

FIG. 8 is a conceptual diagram of a second exemplary embodiment of an antenna according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF THE INVENTION

Hereinafter, exemplary embodiments of the present invention will be described in detail with reference to the accompanying drawings. In the figures, even though the parts are illustrated in different drawings, it should be understood that like reference numbers refer to the same or equivalent parts of the present invention. When it is judged that specific description on known configurations or functions related in the description of the present invention may unnecessarily obscure the essentials of the present invention, the detailed description will be omitted. Hereinafter, exemplary embodiments of the present invention will be described. However, it should be understood that the technical spirit of the invention is not limited to the specific embodiments, but may be changed or modified in various ways by those skilled in the art.

The present invention suggests a series fed microstrip patch array antenna which is available at a millimeter wave band (specifically, 77 GHz).

According to the present invention, a width of a feeder is changed in order to secure a side lobe level, without changing a radiator.

According to the present invention, in order to form a radiation pattern suitable for a vehicle radar application field and simplify the manufacturing process due to a high frequency and a short wavelength, a resistor or ground is not provided at an end terminal.

The present invention has a structure which is applicable to an array antenna to implement a 45 degree polarized wave.

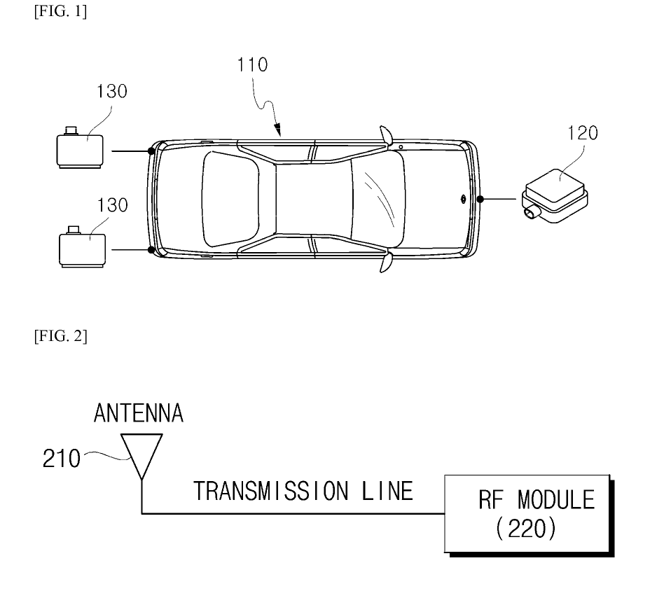

FIG. 1 is a conceptual diagram of a vehicle in which a radar according to an exemplary embodiment of the present invention is mounted.

The present invention relates to an antenna which is mounted in a radar of a vehicle 110. The radar is mounted at a front 120 or rear sides 130 of the vehicle to provide a distance and a speed of a preceding vehicle. An operational frequency of the radar is broadly allocated to a 24 GHz band and a 77 GHz band and specifically, the 77 GHz band is a millimeter wave band and is mainly applied to a front radar 120 having a long detectable range.

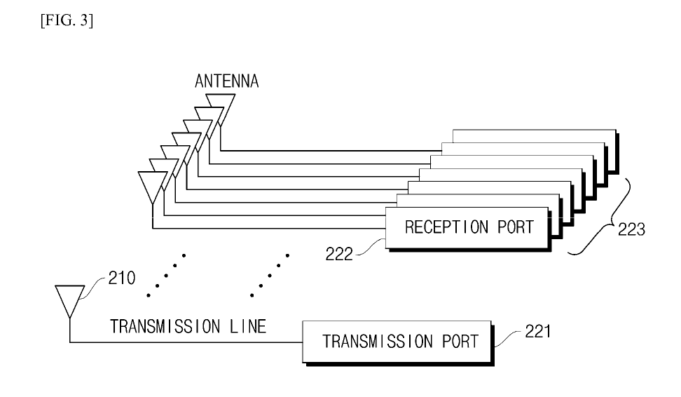

FIGS. 2 and 3 are diagrams of exemplary embodiments of an antenna and an RF module which configure a millimeter wave radar for a vehicle.

In FIG. 2, an antenna 210 transmits and receives an electromagnetic wave in a desired direction and a first RF module 220 transmits or receives a millimeter wave signal which is used for a radar. In this case, the antenna 210 is configured to be connected with the first RF module 220 using a transmission line.

FIG. 3 illustrates an antenna module including a plurality of antennas 210 and a second RF module 223 including one transmission port 221 and a plurality of reception ports 222. The plurality of antennas 210 is arranged to each other to be connected to a reception port of the second RF module 223 and extracts a transmission signal which is reflected from a target to estimate a range, an angle, and a speed of the target.

According to the exemplary embodiment of the present invention, as illustrated in FIGS. 2 and 3, as the antenna 210, a serial fed microstrip patch array antenna which adjusts a width of a feeder in order to secure a side lobe level is implemented.

Generally, as a method for adjusting radiant quantity of the radiator arranged to secure a side lobe level, there is a method for changing a width of the radiator. However, when the width of the radiator is changed, a resonance characteristic of the radiator is also changed so that the radiator needs to be redesigned in order to equalize resonance frequencies of radiators having different widths.

However, according to the exemplary embodiment of the present invention, the side lobe level is secured by maintaining all the radiators with the same shape and changing a width of the feeder to equally change the radiant quantity of the radiators. Therefore, according to the exemplary embodiment of the present invention, the radiator does not need to be redesigned so that design easiness is relatively large and when a shape of the radiator is changed for a specific polarization characteristic, all radiators have the same radiating characteristic.

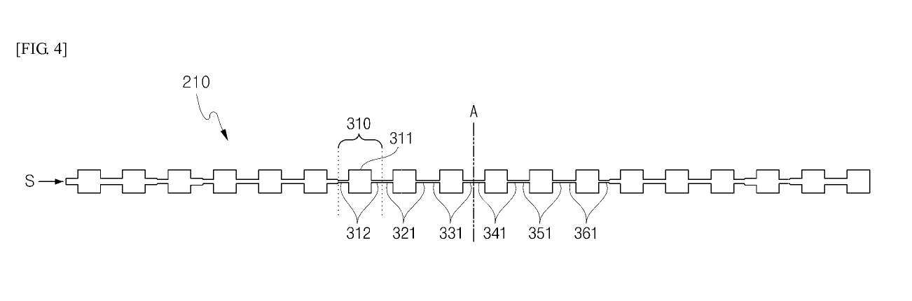

FIG. 4 is a conceptual diagram of a first exemplary embodiment of an antenna according to an exemplary embodiment of the present invention.

According to the present invention, an antenna 210 is configured by an array of radiators which form a desired radiation pattern and feeders which connect the radiators. Specifically, the antenna 210 is configured by an array of unit elements 310 each including a specific radiator 311 and a feeder 312 which connects adjacent radiators at both end terminals of the radiator 311.

In the antenna 210, a radiator at an end terminal which is opposite to a radiator to which a signal S is applied is open.

The antenna 210 is configured by feeders 312, 321, 331, 341, 351, and 361 which are symmetric with each other with respect to a center A of a plurality of radiators. That is, with respect to a point A, a first feeder 312 has the same width as a sixth feeder 361, a second feeder 321 has the same width as a fifth feeder 351, and a third feeder 331 has the same width as a fourth feeder 341. When an odd number of radiators are arranged, feeders of a radiator which are opposite to each other with respect to a radiator at a center A have the same width.

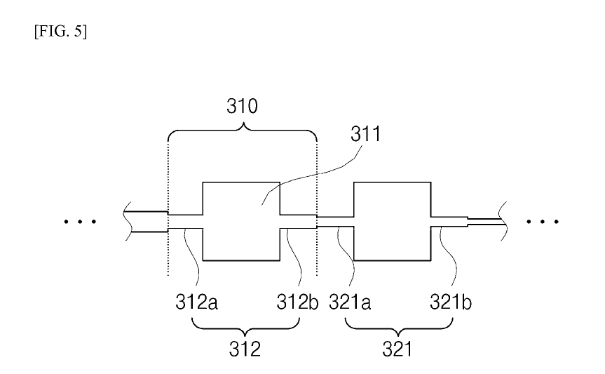

FIG. 5 is an enlarged view enlarging a first unit element 310 and a second unit element which is adjacent to the first unit element 310 in the antenna of FIG. 4.

In an antenna 210 according to an exemplary embodiment of the present invention, all radiators have the same configuration. When a 1a-th feeder 312a and a 1b-th feeder 312b which are formed at both sides of a radiator 311 of a first unit element 310 are configured to have the same width, similarly, a 2a-th feeder 321a and a 2b-th feeder 321b which are formed at both sides of a radiator of a second unit element which is adjacent to the first unit element 310 are configured to have the same width.

The antenna 210 according to the exemplary embodiment of the present invention adjusts a width of each feeder in order to secure a side lobe level of an array antenna configured by an array of radiators. Accordingly, the 1a-th feeder 312a and the 1b-th feeder 312b are configured to have the same width and the 2a-th feeder 321a and the 2b-th feeder 321b are configured to have the same width but the first feeders 312a and 312b have a different width from that of the second feeders 321a and 321b.

In the meantime, a length of feeders having different thicknesses which are connected between the radiators is approximately half a guided wavelength for feeding the same phase to the radiator.

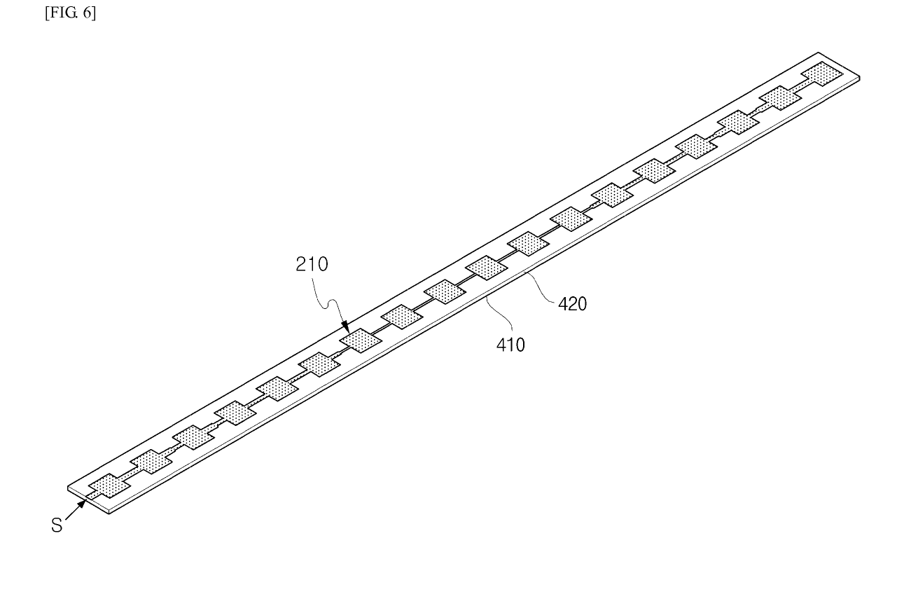

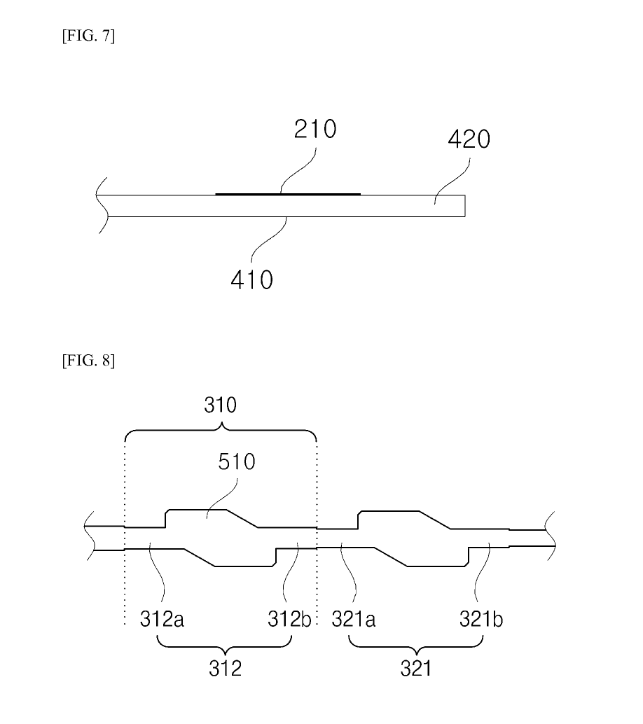

FIG. 6 is a perspective view of an antenna according to an exemplary embodiment of the present invention and FIG. 7 is a side view of an antenna according to an exemplary embodiment of the present invention.

As illustrated in FIGS. 6 and 7, an antenna 210 according to an exemplary embodiment of the present invention is configured on a dielectric substrate 420, such as Teflon, having a ground plane 410. This uses a general PCB process so that mass production may be achieved.

FIG. 8 is a conceptual diagram of a second exemplary embodiment of an antenna according to an exemplary embodiment of the present invention.

FIG. 8 illustrates a modified radiator of FIG. 4. A first radiator 311 may be applied as a second radiator 510 which is partially modified as an example to be carried out. The second radiator 510 illustrated in FIG. 8 has a structure in which opposite corners of the radiator are chamfered in order to implement 45 degree polarization which is a requirement of an antenna of a vehicle radar. In the example to be carried out, similarly to the radiator 311 of FIG. 4, second radiators 510 to be modified have a similar structure without causing significant structural modification when the second radiators are arranged. Therefore, when the antenna 210 is designed, the same radiators are used and only a width of a feeder is modified to adjust a side lobe level.

The exemplary embodiment of the present invention has been described above with reference to FIGS. 1 to 8. Hereinafter, a preferred embodiment of the present invention which may be implemented by the exemplary embodiment of the present invention will be summarized.

A patch array antenna according to a preferred embodiment of the present invention includes a first unit element and a second unit element.

The first unit element includes a first patch which creates a predetermined radiation pattern and first feeders which are formed at both sides of the first patch and have the same width. The patch is the same concept as a radiator.

The second unit element is adjacent to the first unit element and includes a second patch which creates a radiation pattern and second feeders which are formed at both sides of the second patch and have the same width. However, the width of the second feeders is different from the width of the first feeders.

In the first unit element, the width of the first feeder is adjusted in accordance with a radiant quantity related with the radiation pattern. For example, the width of the first feeder may be adjusted to be in inverse proportion to the radiant quantity. As an example to be carried out, as the width of the first feeder is decreased, the radiant quantity is increased but as the width of the first feeder is increased, the radiant quantity is relatively reduced.

In the above description, the first feeders may have a larger width than the second feeders.

The patch array antenna according to the present invention may further include a third unit element.

The third unit element is adjacent to the second unit element, and includes a third patch which creates a radiation pattern and third feeders which are formed at both sides of the third patch and have the same width.

The first feeders of the first unit element, the second feeders of the second unit element, and the third feeders of the third unit element have different widths from each other and the widths of the feeders are adjusted in accordance with the radiant quantity of individual unit elements in order to secure a side lobe level of the array antenna. As an example to be carried out, the first feeders of the first unit element which is disposed at one side have the largest width, the third feeders of the third unit element which is disposed at the other side have the smallest width, and the second feeders of the second unit element which is disposed between the first unit element and the third unit element may have a width which is smaller than that of the first feeders and larger than that of the third feeders.

The patch array antenna according to the present invention may further include a fourth unit element and a fifth unit element.

The fourth unit element is adjacent to the second unit element, and includes a fourth patch which creates a radiation pattern and fourth feeders which are formed at both sides of the fourth patch and have the same width.

The fifth unit element is adjacent to the fourth unit element, and includes a fifth patch which creates a radiation pattern and fifth feeders which are formed at both sides of the fifth patch and have the same width.

A width of each feeder is adjusted in accordance with a radiant quantity of each unit element. As an example to be carried out, the fourth feeders have the same width as the second feeders and the fifth feeders have the same width as the first feeders.

In the meantime, the first unit element and the second unit element may be formed on a dielectric substrate. Specifically, the first unit element and the second unit element may be formed on the dielectric substrate as a Teflon type or a printed circuit board (PCB) type on which a ground plane is formed.

In the meantime, the first patch and the second patch may be formed to have the same shape as any one of a polygon and a polygon in which opposite corners are chamfered.

In the meantime, the first feeders and the second feeders may have the same length based on a guided wavelength.

The patch array antenna according to the present invention may be implemented by a microstrip antenna having a series fed structure.

In the meantime, the patch array antenna may include N patches including the first patch and the second patch. In this case, among the N patches, one side of each of patches which are disposed at an end terminal is open. That is, a patch which is not disposed at an end terminal generally have two feeders at both sides of the patch, but a patch which is disposed at an end terminal have one feeder at one side of the patch, and the one feeder is located at the one side which is connected to the other patch. As an example to be carried out, an end terminal which is opposite to the feeder of the array antenna is disposed so as not to include a feeder at the end terminal and be open.

A radar signal transmitting and receiving apparatus according to the present invention includes a radar signal generating unit and a patch array antenna. Such a radar signal transmitting and receiving apparatus may be mounted in a vehicle.

The radar signal generating unit generates a radar signal and is the same concept as an RF module.

The patch array antenna outputs a radar signal which is generated by the radar signal generating unit to the outside and receives a radar signal which is reflected to return. A characteristic of the patch array antenna has been described in detail above so that detailed description thereof will be omitted.

In the meantime, the patch array antenna may output the radar signal as a polarized wave signal having a predetermined angle. Desirably, the patch array antenna may output the radar signal as a 45 degree polarized wave signal. The 45 degree polarized wave signal may suppress mutual interference because polarized waves between approaching opposite radars are perpendicular to each other.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A patch array antenna, comprising:
a first unit element which includes a first patch which creates a predetermined radiation pattern and first feeders which are formed at both sides of the first patch and have the same width; and
a second unit element which is adjacent to the first unit element and includes a second patch which creates the radiation pattern and second feeders which are formed at both sides of the second patch and have the same width wherein the width of the second feeders is different from the width of the first feeders.

2. The patch array antenna of claim 1, wherein the width of the first feeder in the first unit element is adjusted in accordance with a radiant quantity related with the radiation pattern.

3. The patch array antenna of claim 2, wherein the width of the first feeder is adjusted so as to be in inverse proportion to the radiant quantity.

4. The patch array antenna of claim 1, further comprising:
a third unit element which is adjacent to the second unit element and includes a third patch which creates a radiation pattern and third feeders which are formed at both sides of the third patch and have the same width;
wherein the first feeders of the first unit element, the second feeders of the second unit element, and the third feeders of the third unit element have different widths from each other and the widths of the individual feeders are adjusted in accordance with the radiant quantity of the individual unit elements.

5. The patch array antenna of claim 1, further comprising:
a fourth unit element which is adjacent to the second unit element and includes a fourth patch which creates a radiation pattern and fourth feeders which are formed at both sides of the fourth patch and have the same width; and
a fifth unit element which is adjacent to the fourth unit element and includes a fifth patch which creates a radiation pattern and fifth feeders which are formed at both sides of the fifth patch and have the same width;
wherein the widths of the feeders are adjusted in accordance with the radiant quantity of the unit elements.

6. The patch array antenna of claim 1, wherein the first unit element and the second unit element are formed on a dielectric substrate.

7. The patch array antenna of claim 6, wherein the first unit element and the second unit element are formed on the dielectric substrate as a Teflon type or a printed circuit board (PCB) type on which a ground plane is formed.

8. The patch array antenna of claim 1, wherein the patch array antenna includes a predetermined number of patches including the first patch and the second patch, and among the predetermined number of patches, at least one patch which is disposed at an end terminal has one open side.

9. The patch array antenna of claim 8, wherein at least one patch which is disposed at the end terminal does not have one feeder between both feeders disposed at both sides which are not connected with a feeder of the other patch.

10. The patch array antenna of claim 1, wherein the first patch and the second patch are formed to have the same shape as any one of a polygon and a polygon and a polygon in which opposite corners are chamfered.

11. The patch array antenna of claim 1, wherein the first feeders and the second feeders have the same length based on a guided wavelength.

12. The patch array antenna of claim 1, wherein the patch array antenna is a microstrip antenna having a series fed structure.

13. A radar signal transmitting and receiving apparatus, comprising:
a radar signal generating unit which generates a radar signal; and
a patch array antenna including a first unit element which outputs the radar signal to the outside and receives the radar signal which returns by being reflected and includes a first patch which creates a predetermined radiation pattern and first feeders which are formed at both sides of the first patch and have the same width; and a second unit element which is adjacent to the first unit element and includes a second patch which creates the radiation pattern and second feeders which are formed at both sides of the second patch and have the same width wherein the width of the second feeders is different from the width of the first feeders.

14. The apparatus of claim 13, which is mounted in a vehicle.

15. The apparatus of claim 13, wherein the patch array antenna outputs the radar signal as a polarized wave signal having a predetermined angle.
